(19) United States
(12) Patent Application Publication
(10) Pub. No.: US 2009/0229379 A1
(43) Pub. Date: Sep. 17, 2009

(54) Sensor-Incorporated Wheel Support Bearing Assembly

(76) Inventors: Takayoshi Ozaki, Shizuoka (JP); Takashi Koike, Shizuoka (JP); Tomomi Ishikawa, Shizuoka (JP)

Correspondence Address: STAAS & HALSEY LLP, SUITE 700, 1201 NEW YORK AVENUE, N.W., WASHINGTON, DC, 20005, US

(21) Appl. No.: 11/886,917

(22) PCT Filed: Mar. 3, 2006
(86) PCT No.: PCT/JP2006/304061

§ 371 Date: Sep. 21, 2007

(30) Foreign Application Priority Data
Mar. 22, 2005 (JP) 2005-080862

(51) Int. Cl. G01L 1/12

(52) U.S. Cl. 73/862.69

(57) ABSTRACT

A wheel support bearing assembly includes an outer member (1) having an inner peripheral surface formed with raceway surfaces (4), an inner member (2) having an outer peripheral surface formed with raceway surfaces (5) in face-to-face relation with the raceway surfaces (4) in the outer member (1), and rows of rolling elements (3) interposed between the raceway surfaces (4, 5). A ring member (21) made of a magnetostrictive material is fixed to the outer peripheral surface of the inner member (2), and a magnetostrictive sensor (23) and a displacement sensor (22) are disposed in the outer member (1) or a member (24) fixed to the outer member (1) to confront the ring member. The magnetostrictive sensor (23) measures a change in magnetic strain occurring in the ring member (21) and the displacement sensor (22) measures the distance between the ring member (21) and the displacement sensor (22).

### BACKGROUND OF THE INVENTION

1. Field of the Invention

The present invention relates to a sensor-incorporated bearing assembly equipped with a load sensor for detecting a load imposed on a bearing portion of a wheel.

2. Description of the Prior Art

For safety travel of an automotive vehicle, the wheel support bearing assembly equipped with a sensor for detecting the rotational speed of one of automotive wheels has hitherto been well known in the art. While the automobile traveling safety precaution is hitherto generally taken by detecting the rotational speed of a wheel of various parts, but it is not sufficient with the detection of only the rotational speed of the wheel and, therefore, it is required to achieve an improved safety control with the use of other sensor signals.

In view of this, it may be contemplated to achieve an attitude control of an automotive vehicle based on a load acting on each of wheels during travel of the automotive vehicle. By way of example, a large load acts on the outside wheels during the cornering, on the wheels on one side during the run along left and right inclined road surfaces or on the front wheels during the braking and, thus, a varying load acts on the vehicle wheels. Also, in the case of the uneven live load, the loads acting on those wheels tend to become uneven. For this reason, if the loads acting on the wheels can be detected as needed, suspension systems for the vehicle wheels can be controlled beforehand based on results of detection of the loads so that the attitude control of the automotive vehicle during the traveling thereof (for example, prevention of a rolling motion during the cornering, prevention of downward settling of the front wheels during the braking, and prevention of downward settling of the vehicle wheels brought about by the uneven distribution of live loads) can be accomplished. However, no space for installation of the load sensor for detecting the load acting on the respective vehicle wheel is available and, therefore, the attitude control through the detection of the load can hardly be realized.

Also, in the event that in the near future the steer-by-wire is introduced to provide the system in which the wheel axle and the steering come not to be coupled mechanically with each other, and such system is increasingly used, information on the road surface comes to be required to transmit to the steering wheel held by a driver by detecting a load acting in a wheel axis direction.

In order to meet those needs, it has been suggested to use various sensors such as temperature sensor, vibration sensor and load sensor in the wheel support bearing assembly so that in addition to the rotational speed, various parameters useful for the travel of the automotive vehicle can be detected. (See, for example, the Japanese Laid-open Patent Publications No. 2004-45219 and No. 2004-198210.)

The first mentioned patent document No. 2004-45219 discloses the determination of the type of load, the direction of the load and the magnitude of the load by the utilization of signals provided for by eight displacement sensors for detection of a horizontal load Fx, an axial load Fy acting in a direction parallel to the axis of rotation, a vertical load Fz, a moment load Mx acting around a horizontal axis, a moment load My acting around a rotation axis and a moment load Mz acting around a vertical axis, all acting on the wheel support bearing assembly. Also, the second mentioned patent document No. 2004-198210 discloses, in combination with the displacement sensors, the additional use of a separate sensor confronting the corresponding displacement sensor in a radial direction or a thrust direction of the bearing assembly.

However, the bearing assembly disclosed in any one of the above discussed patent documents requires the use of an increased number of component parts (sensors) to be added for the measurement of those loads and, therefore, it is unavoidable to increase the cost and the weight of the bearing assembly. Also, the use of the increased number of the sensors eventually results in increase of the size of a detecting circuit and/or a controller to be disposed downstream of the sensors, unnecessarily accompanied by increase of the cost and the weight of the bearing assembly and, therefore, the bearing assembly disclosed in any one of the above discussed patent documents is ineffective to accomplish reduction in cost and weight, both of which have been desired for in the wheel support bearing assembly.

### SUMMARY OF THE INVENTION

An object of the present invention is to provide a sensor-incorporated wheel support bearing assembly, in which a load sensor unit can be compactly mounted on an automotive vehicle and in which a load acting on a wheel can be detected stably.

A sensor-incorporated wheel support bearing assembly according to the present invention is a bearing assembly for rotatably supporting a wheel relative to an automotive body structure, which includes an outer member having an inner peripheral surface formed with double rows of raceway surfaces, an inner member having an outer peripheral surface formed with double rows of raceway surfaces in face-to-face relation with the raceway surfaces in the outer member, and double rows of rolling elements interposed between the raceway surfaces in the outer member and the raceway surfaces in the inner member, respectively. A ring member made of a magnetostrictive material is fixed to the outer peripheral surface of the inner member, and a magnetostrictive sensor and a displacement sensor are provided in the outer member or a member secured to the outer member. The magnetostrictive sensor is used to measure a change in magnetic strain of the ring member whereas the displacement sensor is used to measure the distance between the ring member and the displacement sensor. The displacement sensor, the magnetostrictive sensor and the ring member form the load sensor unit.

According to this construction, when during the travel of the automotive vehicle, a vertical load and a horizontal load are imposed on the inner member, the distance between the inner member and the outer member changes and, correspondingly, the distance between the ring member on the outer peripheral surface of the inner member and the displacement sensor changes. The displacement sensor measures this displacement. Also, when an axial load acting in the longitudinal direction or rotation axis of the inner member is imposed on the inner member, the magnetic permeability of the ring member made of a magnetostrictive material changes and this change in magnetic permeability is measured by the magnetostrictive sensor. Accordingly, the vertical load, the horizontal load and the axial load can be detected with the displacement sensor and the magnetostrictive sensor. In such case, since the ring member concurrently serves as a to-be-detected element for both of the displacement sensor and the magnetostrictive sensor, the load sensor unit can have a compact construction. Hence, the load sensor unit can be compactly installed on the automotive vehicle and the load acting on the wheel can be detected stably.

In the present invention, the wheel support bearing assembly may be provided with a load calculator for determining the load, which acts on the inner member, by calculating respective outputs from the magnetostrictive sensor and the displacement sensor.

In the case of this construction, if the relation between an output of the amount of displacement detected by the displacement sensor and the vertical and horizontal loads and the relation between an output of the amount of change in magnetic permeability detected by the magnetostrictive sensor and the axial load are predetermined from experiments and simulations and those relations are then set in the load calculator in the form of, for example, equations and/or table, the vertical load Fz, the horizontal load Fz and the axial load Fy can be calculated from the respective outputs of the displacement sensor and the magnetostrictive sensor. When those calculated values are introduced into an ECU (Electric Control Unit) or the like of the automotive vehicle, they can be used for the control of the traveling stability of the automotive vehicle and the transmission of information on the road surface in the steer-by-wire system.

In the present invention, the sensor-incorporated wheel support bearing assembly may be provided with a wheel receiving load calculator for calculating the respective outputs from the magnetostrictive sensor and the displacement sensor to determine a road force transmitted from the road surface to the wheel. In the case of this construction, the wheel receiving load calculator calculates the force acting between the wheel and the road surface by substituting the amount of displacement detected by the displacement sensor and the amount of change in magnetic permeability detected by the magnetostrictive sensor into the equation of the relation among the amount of displacement, the amount of change in magnetic permeability and the various loads, which relation is predetermined from experiments and simulations. Accordingly, when the calculated value by the wheel receiving load calculator is introduced into the ECU (Electric Control Unit) or the like of the automotive vehicle, it can be used for the control of the traveling stability of the automotive vehicle and the transmission of information on the road surface in the steer-by-wire system.

In the present invention, the ring member may be made of an Fe—Ni alloy containing Ni in a quantity equal to or higher than 80 wt %. The use of the Fe—Ni alloy containing Ni in a quantity equal to or higher than 80 wt % is advantageous in obtaining an excellent magnetic strain characteristic, resulting in increase of the detecting accuracy of the load sensor unit.

Also, the ring member may be made of a magnetostrictive material having a negative magnetostriction constant such as Ni. Considering that the magnetostrictive sensor detects the displacement (a change in gap) between the magnetostrictive sensor and the magnetostrictive material in addition to the change in magnetic permeability resulting from the magnetostrictive effect, if the magnetostrictive material having a positive magnetostriction constant is used to form the ring member 21, a sensor output component resulting from the magnetostrictive effect occurring in the magnetostrictive material represents a characteristic reverse to that of a sensor output component resulting from the displacement between the magnetostrictive sensor 23 and the magnetostrictive material and, therefore, there is the possibility that those sensor outputs may interfere with each other. On the other hand, if the magnetostrictive material having a negative magnetostriction constant is used to form the ring member 21, a sensor output component resulting from the magnetostrictive effect occurring in the magnetostrictive material represents the same characteristic as that of the sensor output component resulting from the displacement between the magnetostrictive sensor and the magnetostrictive material and, therefore, there is no possibility that the sensor outputs interfere with each other.

In addition, the ring member may have a surface plated with copper. Particularly in the case that the displacement sensor is of an eddy current type, forming the copper plating on the ring member is preferred. Since in the case of the eddy current type displacement sensor, the frequency of change of magnetic fields is high, magnetic fluxes emerging from the displacement sensor penetrate only into a surface of a sensor target. In other words, the displacement sensor of the eddy current type detects information only from the target surface. On the other hand, the lower the electric resistivity of the target surface, the higher the sensor sensitivity of the displacement sensor. Accordingly, the formation of a thin film such as a copper plating, having a low electric resistivity, on the target surface is effective to achieve a high sensitivity sensing of the displacement sensor.

In the present invention, the displacement sensor may be of a reluctance type. Also, the displacement sensor may be of a type utilizing a combination of a magnet and a magnetic detecting element capable of providing an analog output. Where the displacement sensor is of the eddy current type or the reluctance type, an excellent detecting accuracy can be obtained, but where the displacement sensor is of the type utilizing the combination of the magnet and the magnetic detecting element, the structure of the displacement sensor can be simplified and inexpensive.

As hereinabove described, the sensor-incorporated wheel support bearing assembly according to the present invention is so designed as to be a bearing assembly for rotatably supporting a wheel relative to an automotive body structure, which includes the outer member having the inner peripheral surface formed with double rows of raceway surfaces, the inner member having the outer peripheral surface formed with double rows of raceway surfaces in face-to-face relation with the raceway surfaces in the outer member, and double rows of rolling elements interposed between the raceway surfaces in the outer member and the raceway surfaces in the inner member, the ring member made of a magnetostrictive material being fixed to the outer peripheral surface of the inner member, and the magnetostrictive sensor and the displacement sensor being provided in the outer member or a member secured to the outer member, the magnetostrictive sensor being used to measure a change in magnetic strain of the ring member whereas the displacement sensor is used to measure the distance between the ring member and the displacement sensor. Accordingly, the displacement sensor, the magnetostrictive sensor and the ring member forming the load sensor unit can be installed in the automotive vehicle compactly and the load acting on the wheel can be detected stably.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a sectional view of a sensor-incorporated wheel support bearing assembly according to a preferred embodiment of the present invention;

FIG. 2 is a side view showing the arrangement of displacement sensors and magnetostrictive sensors, both employed in the wheel support bearing assembly of FIG. 1;

FIG. 3 is a plan view showing an example of the displacement sensor;

FIG. 4A is a fragmentary front elevational view showing an example of the magnetostrictive sensor; and

FIG. 4B is a cross-sectional view taken along the line VI-VI in FIG. 4A.

### DETAILED DESCRIPTION OF THE EMBODIMENTS

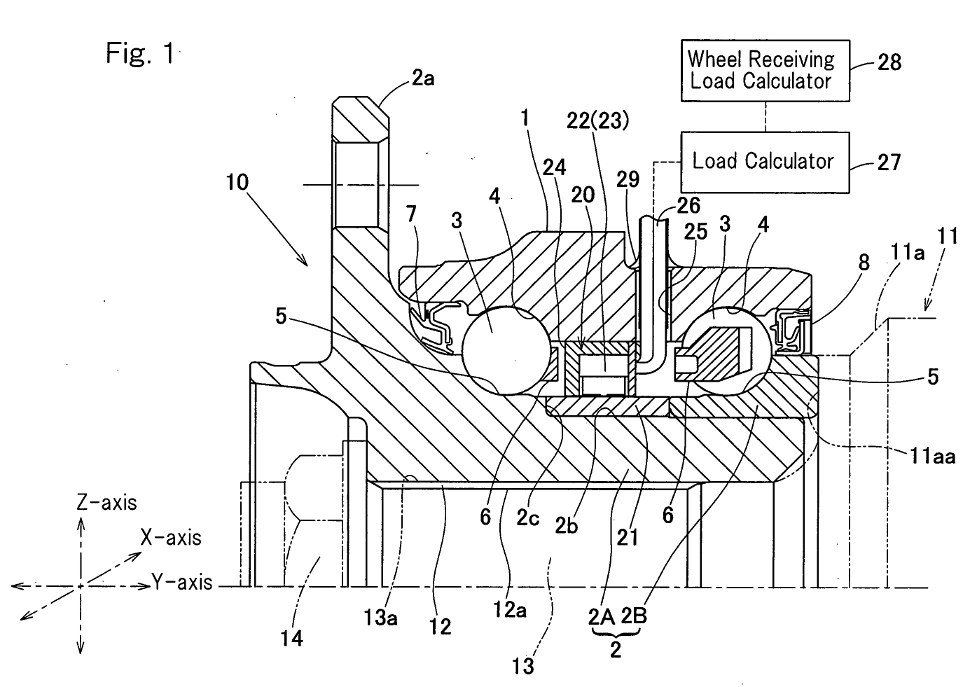

A preferred embodiment of the present invention will now be described with particular reference to FIGS. 1 to 3. This embodiment is directed to a third-generation wheel support bearing assembly of an inner-race rotating type that is used for the support of a vehicle drive wheel. It is to be noted that in the specification herein set forth, the terms “outboard” and “inboard” represent one side of the vehicle body away from the longitudinal center of the vehicle body and the other side of the vehicle body close to the longitudinal center of the vehicle body, respectively. In FIG. 1, a right portion represents the inboard side whereas a left portion represents the outboard side.

The wheel support bearing assembly 10 shown in FIG. 1 has a horizontally extending longitudinal axis and includes an outer member 1 having an inner peripheral surface formed with a plurality of, for example, double rows of raceway surfaces 4, an inner member 2 having an outer peripheral surface formed with double rows of raceway surfaces 5 opposed to those raceway surfaces 4, and double rows of rolling elements 3 interposed between the raceway surfaces 4 and the raceway surfaces 5. This wheel support bearing assembly 10 is in the form of a double row angular contact ball bearing, in which each of the raceway surfaces 4 and 5 represents an arcuate shape in section and the raceway surfaces 4 and 5 are so formed as to have respective contact angles held in back-to-back relation with each other. The rolling elements 3 are in the form of a ball and are retained by a retainer 6 employed for each row of those rolling elements 3. Outboard and inboard open ends of an annular bearing space delimited between the inner and outer members 2 and 1 are sealed by respective contact type sealing devices 7 and 8.

The outer member 1 is a member that serves as a stationary member and is connected to a knuckle (not shown) of an automotive vehicle body structure by means of bolts.

The inner member 2 is a member that serves as a rotatable member and is made up of a hub axle 2A having an outer peripheral surface formed with a wheel mounting flange 2a, and a separate inner race 2B mounted fixedly on the outer peripheral surface at an inboard end of the hub axle 2A. The raceway surfaces 5 are formed in the hub axle 2A and the inner ring 2B, respectively. This hub axle 2A is coupled with an outer race 11a, which serves as one of coupling members of a constant velocity universal joint 11. The hub axle 2A has a center bore 12 defined therein, and a stem 13 formed integrally with the constant velocity universal joint outer race 11a is inserted into the center bore 12. This constant velocity universal joint outer race 11a is firmly coupled with the inner member 2 with a nut 14 fastened to a free end of the stem 13 that has been passed through the center bore 22. At this time, a stepped face 11aa so defined in the constant velocity universal joint outer race 11a as to be oriented outboard is urged against an inboard-facing end face of the inner race 2B, then press-fitted onto the hub axle 2A, to firmly sandwich the inner member 2 between the constant velocity universal joint outer race 11a and the nut 14 in an axial direction of the bearing assembly 10. The center bore 12 in the hub axle 2A is formed with a plurality of spline grooves 12a that are coupled through spline engagement with corresponding spline projections 13a defined in an outer peripheral surface of the stem 13 then inserted into the center bore 12.

A load sensor unit 20 is accommodated within the bearing space of the wheel support bearing assembly 10 and is positioned substantially intermediate between the raceway surfaces 4 and 5. This load sensor unit 20 includes a ring member 21 made of magnetostrictive material secured to the outer peripheral surface of the inner member 2, and displacement sensors 22 and magnetostrictive sensors 23 both so arranged on the outer member 1 as to confront the ring member 21.

The outer peripheral surface of the hub axle 2A is radially inwardly stepped or decreased in diameter from a portion thereof adjacent the outboard raceway 5 to the inboard end thereof to form a reduced diameter outer peripheral surface 2b. The ring member 21 is press-fitted on the reduced diameter outer peripheral surface 2b of the hub axle 2A and is axially fixedly positioned while being sandwiched between a stepped face 2c defined at an outboard end of the reduced diameter outer peripheral surface 2b and an outboard-facing end face of the inner race 2B.

A material used to form the ring member 21 is an Fe—Ni alloy containing Ni in a quantity equal to or higher than, for example, 80 wt %. If the Fe—Ni alloy is employed for the ring member 21, the magnetostrictive characteristic of the ring member 21 can be enhanced and the detecting accuracy of the magnetostrictive sensor 23 can therefore be increased.

As the material used to form the ring member 21, a magnetostrictive material having a negative magnetostriction constant such as Ni may be employed. Considering that the magnetostrictive sensors 23 detect not only a change in magnetic permeability resulting from the magnetostrictive effect, but also a displacement (change in gap) between the magnetostrictive sensors 23 and the magnetostrictive material, if the magnetostrictive material having a positive magnetostriction constant is used to form the ring member 21, a sensor output component resulting from the magnetostrictive effect occurring in the magnetostrictive material represents a characteristic reverse to that of a sensor output component resulting from the displacement between the magnetostrictive sensors 23 and the magnetostrictive material and, therefore, there is the possibility that those sensor outputs may interfere with each other. On the other hand, if the magnetostrictive material having a negative magnetostriction constant is used to form the ring member 21, a sensor output component resulting from the magnetostrictive effect occurring in the magnetostrictive material represents the same characteristic as that of the sensor output component resulting from the displacement between the magnetostrictive sensors 23 and the magnetostrictive material and, therefore, there is no possibility of the sensor outputs interfering with each other.

Also, the ring member 21 may have a copper plating formed on a surface thereof. Particularly in the case of the displacement sensors 22 of the eddy current type, the use of the copper plating on the surface of the ring member 21 is preferable. Since in the case of the displacement sensor of an eddy current type the frequency of change of magnetic field is high, magnetic fluxes emerging from the displacement sensor 22 penetrate only into a surface of a sensor target. In other words, the displacement sensor of the eddy current type detects information only from the target surface. On the other hand, the lower the electric resistivity of the target surface, the higher the sensor sensitivity of the displacement sensor. Accordingly, formation of a thin film such as the copper plating, having a low electric resistivity, on the target surface is effective to achieve a high sensitivity sensing of the displacement sensor 22.

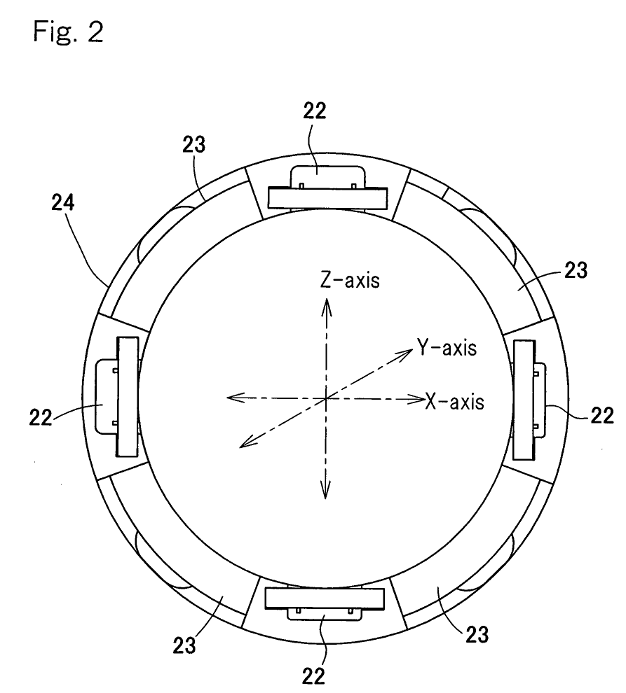

The displacement sensor 22 is operable to measure the distance between the displacement sensor 22 and the ring member 21 confronting the displacement sensor 22. In this embodiment, as shown in FIG. 2, four displacement sensors 22 are employed and are so arranged on the outer member 1 in a circumferential direction of the outer member 1 to be spaced an equal distance, that is, 90° from each other while confronting the ring member 21. Of the four displacement sensors 22, two displacement sensors 22 are arranged along a vertical Z-axis direction on upper and lower sides of the outer member 1, respectively, with respect to the vertical axis of the automotive vehicle whereas the two remaining displacement sensors 22 are arranged along a horizontal X-axis perpendicular to the vertical Z-axis on forward and rearward sides of the outer member 1, respectively, with respect to the direction of travel of the automotive vehicle.

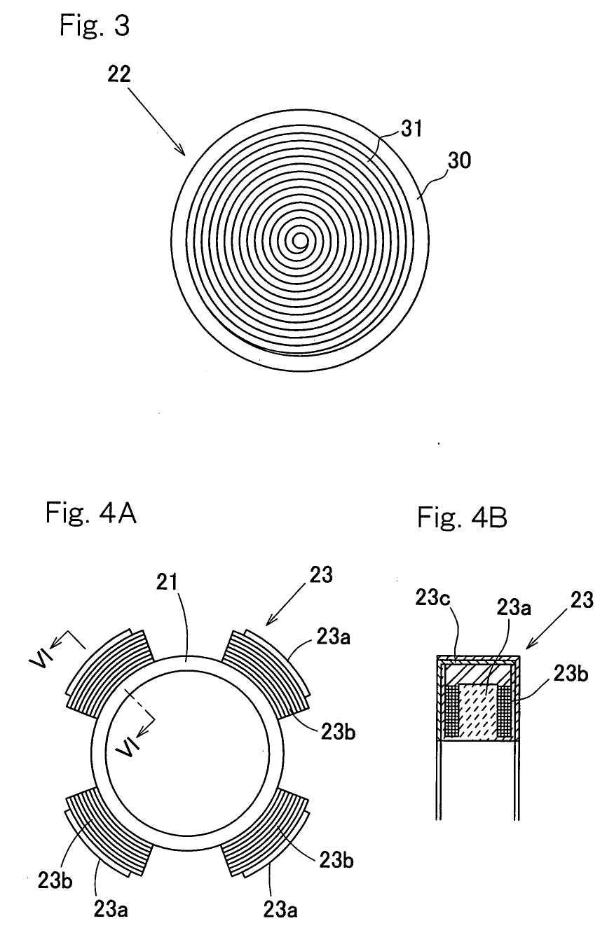

For each of the displacement sensors 22, any suitable sensor can be employed, but one example thereof includes an eddy current type displacement sensor utilizing a coil winding as shown in FIG. 3. As shown in FIG. 3, the displacement sensor 22 includes a sensor support member 30 made of a resin and a coil winding 31 arranged spirally on the sensor support member 30. It is to be noted that the coil winding 31 may be wound in either a single layer or multiple layers. The displacement sensor 22 may be a reluctance type capable of detecting a displacement by the utilization of a change in inductance of the coil winding 31, which results from change in distance (change of an air gap) between the displacement sensor 22 and the outer peripheral surface of the ring member 21, which is a sensor target.

Additionally, the displacement sensor 22 may be of a type utilizing a combination of a magnet and a magnetic detecting element (for example, a Hall element) capable of providing an analog output. In such case, the ring member 21 has to be made of a ferromagnetic material. Although in the case of the eddy current type displacement sensor 22, the cost of an electric circuit designed to be disposed downstream of the displacement sensor 22 for signal processing will be high, the displacement sensor 22 utilizing the magnetic detecting element such as a Hall element is effective to reduce the cost of the electric circuit.

The magnetostrictive sensors 23 is operable to measure a change in magnetic strain occurring in the ring member 21. In this embodiment, four magnetostrictive sensors 23 are employed and are so arranged at respective positions of the outer member 1 displaced 45° from the neighboring displacement sensors 22 in a direction circumferentially of the ring member 21 as to confront the outer peripheral surface of the ring member 21 while spaced an equal distance of 90° from each other in the circumferential direction.

In this embodiment, the four displacement sensors 22 and the four magnetostrictive sensors 23 are secured to a generally or substantially ring-shaped sensor housing 24 so as to assume their respective positions discussed above. This sensor housing 24 is press-fittedly fixed on the inner peripheral surface of the outer member 1 between the raceway surfaces 4 and 4 in the outer member 1. The displacement and magnetostrictive sensors 22 and 23 may be arranged directly on the inner peripheral surface of the outer member 1 with no sensor housing used.

Each of the magnetostrictive sensors 23 includes, for example, a coil bobbin 23a having a coil winding 23b wound around the coil bobbin 23a, and a yoke 23c capped onto the coil bobbin 23a, as shown in FIG. 4. Each magnetostrictive sensor 23 of the above described structure utilizes the magnetostrictive characteristic (that is, the magnetic strain characteristic) of the ring member 21 made of the magnetostrictive material that the magnetic resistance of the ring member 21 undergoes a change in response to stresses imposed on the ring member 21, thereby detecting the strain in the ring member 21 as a change in magnetic resistance of the coil winding 23.

Respective detection signals emerging from the displacement sensors 22 and the magnetostrictive sensors 23 are supplied to a load calculator 27, mounted on the automotive vehicle, through an electric harness 26 extending through a throughhole 25 in the outer member 1. This throughhole 25 is defined in the outer member 1 so as to extend completely across the thickness of the wall of the outer member 1 from the outer peripheral surface thereof to the inner peripheral surface thereof. The harness 26 extending through the throughhole 25 is fixed to the outer member 1 by a sealing member 29, which is concurrently utilized to avoid an ingress of dust and muddy water from the outside into the bearing space of the wheel support bearing assembly 10. The load calculator 27 is operable to detect the load acting on the bearing assembly 10 from the detection signal outputted by the load sensor unit 20. Also, the load calculator 27 is connected to a wheel receiving load calculator 28, which is utilized to detect a road force transmitted from the road surface to the wheel in reference to the load imposed on the bearing assembly which is determined by the load calculator 27. It is to be noted that the load calculator 27 and the wheel receiving load calculator 28 may be mounted at respective locations (for example, an ECU (Electric Control Unit)) separate from the bearing assembly. Also, the load calculator 27 and the wheel receiving load calculator 28 may be formed as an electronic circuit embodied in the form of, for example, an IC chip or a circuit substrate and may be embedded within the sensor housing 24.

The operation of the load sensor unit 20 to detect the load acting on the wheel support bearing assembly 10 will be set forth in the following description.

When during the travel of the automotive vehicle, a vertical load Fz acting in the Z-axis direction and a horizontal load Fx acting in the horizontal X-axis direction are imposed on the hub axle 2A shown in FIG. 1, the distance between the hub axle 2A and the outer member 1 changes, and this change is measured by the displacement sensors 22. Also, when an axial load Fy acting in the Y-axis direction or the direction of the rotation axis of the inner member 2 is imposed on the hub axle 2A, the magnetic permeability of the ring member 21 made of the magnetostrictive material changes, and this change is measured by the magnetostrictive sensors 23 (FIG. 2). Respective detection signals outputted from the displacement and magnetostrictive sensors 22 and 23 are supplied to the load calculator 27. Then, the load calculator 27 calculates the vertical load Fz, the horizontal load Fx and the axial load Fy by substituting the amount of displacement in distance, detected by the displacement sensors 22, and the amount of change in magnetic permeability, detected by the magnetostrictive sensors 23, into an equation of the relation among the amount of displacement in distance, the amount of change in magnetic permeability and the various loads, which relation is predetermined from experiments and simulations. Since the amount of the displacement and the amount of the change are detected by the circumferentially equally spaced four displacement sensors 22 and the similarly circumferentially equally spaced four magnetostrictive sensors 23, it is possible to accomplish the load detection with high accuracy and any influence on the amount of the displacement and the amount of the change in magnetic permeability, resulting from temperature-dependent thermal expansion and shrinkage of the ring member 21, can be removed easily.

Also, the load detected by the load calculator 27 is subsequently supplied to the wheel receiving load calculator 28, and the wheel receiving load calculator 28 then detects the road force acting between the wheel and the road surface.

As hereinbefore fully described, with the sensor-incorporated wheel support bearing assembly 10 according to the present invention, the load sensor unit 20 can be arranged compactly in the automotive vehicle and the load imposed on the wheel can be detected stably. The load determined by the load calculator 27 and the road force acting between the wheel and the road surface, which is determined by the wheel receiving load calculator 28 can, when introduced into the ECU of the automotive vehicle, be applied for the control of the traveling stability of the automotive vehicle and for the transmission of information on the road surface in the steer-by-wire system.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

What is claimed is:

1. A sensor-incorporated wheel support bearing assembly for rotatably supporting a wheel relative to an automotive body structure, which assembly comprises:
an outer member having an inner peripheral surface formed with double rows of raceway surfaces;
an inner member having an outer peripheral surface formed with double rows of raceway surfaces in face-to-face relation with the raceway surfaces in the outer member;
double rows of rolling elements interposed between the raceway surfaces in the outer member and the raceway surfaces in the inner member, respectively;
a ring member made of a magnetostrictive material and fixed to the outer peripheral surface of the inner member;
a magnetostrictive sensor and a displacement sensor both so provided in the outer member or a member secured to the outer member as to confront the ring member; and
wherein the magnetostrictive sensor is operable to measure a change in magnetic strain of the ring member whereas the displacement sensor is operable to measure the distance between the ring member and the displacement sensor.

2. The sensor-incorporated wheel support bearing assembly as claimed in claim 1, further comprising a load calculator for calculating respective outputs from the magnetostrictive sensor and the displacement sensor to determine the load acting on the inner member.

3. The sensor-incorporated wheel support bearing assembly as claimed in claim 1, further comprising a wheel receiving load calculator for calculating respective outputs from the magnetostrictive sensor and the displacement sensor to determine a road force transmitted from the road surface to the wheel.

4. The sensor-incorporated wheel support bearing assembly as claimed in claim 1, wherein the ring member is made of an Fe—Ni alloy containing Ni in a quantity equal to or higher than 80 wt %.

5. The sensor-incorporated wheel support bearing assembly as claimed in claim 1, wherein the magnetostrictive material of the ring member has a negative magnetostriction constant.

6. The sensor-incorporated wheel support bearing assembly as claimed in claim 1, wherein the ring member has a surface plated with copper.

7. The sensor-incorporated wheel support bearing assembly as claimed in claim 1, wherein the displacement sensor employs one of an eddy current type and a reluctance type.

8. The sensor-incorporated wheel support bearing assembly as claimed in claim 1, wherein the displacement sensor includes a combination of a magnet and a magnetic detecting element capable of providing an analog output.

9. The sensor-incorporated wheel support bearing assembly as claimed in claim 1, wherein the inner member includes a hub axle, on which one of the raceway surfaces is defined and the wheel is fixedly mounted, and an inner race mounted on the hub axle and having the other raceway face defined therein; and
wherein the ring member is mounted on an outer peripheral surface of the hub axle and is axially positioned on the hub axle while being sandwiched between a stepped face, defined in the outer peripheral surface of the hub axle, and the inner race.
